(19) United States
(12) Patent Application Publication
(10) Pub. No.: US 2019/0359171 A1
(43) Pub. Date: Nov. 28, 2019

(54) Protective device, system of an electrical card including an electrical circuits and components and method of wiring, installing and locating such device and system to some solenoid designated to protect and control the vehicle starter operation

(71) Applicants: Max Hori, Modiean-macabim-reot (IL); Zacharia Hizmi, Rosh Ha'ayin (IL); Avraham Yaakobson, Petach-Tikva (IL); Ezra Havosha, Modieen (IL)

(72) Inventors: Max Hori, Modiean-macabim-reot (IL); Zacharia Hizmi, Rosh Ha'ayin (IL); Avraham Yaakobson, Petach-Tikva (IL); Ezra Havosha, Modieen (IL)

(21) Appl. No.: 15/986,419

(22) Filed: May 22, 2018

(51) Int. Cl. B60R 25/045; B60R 25/24

(52) U.S. Cl. CPC B60R 25/045; B60R 25/245

(57) ABSTRACT

Protective device, system of some electrical card include an electrical circuits and technological components and method of wiring, installing and locating such device and system to some solenoid designated to protect and control the vehicle starter operation of some motorized automobile solenoid outgoing and ingoing electric connections and components.

Wherein, such electrical card and components accommodates in protective box device of the present invention, wherein, such device fitted by shape to be attached to some of the solenoid sections, and designated to protected, closed and locked some electrical wiring and components exiting from such solenoid and entering to such solenoid.

Wherein, such protective box device designated for securing, accommodating and protecting such electrical card, components and solenoid electrical wiring, designated to protect and prevent access from unauthorized persons for the purpose of preventing vehicles theft. Wherein, such protective box device, electrical card, components and solenoid electrical wiring enabling to control the vehicle solenoid operation by authorized persons, by some bypass electrical circuits closed in the present invention protecting box device by using some coded technologies or some personalized authorized data to some technological components installed in the present invention system controlled from the outside of such device by some devices and system controls the opening and closing of such bypass electrical circuits to enable the operation of such solenoid which operates the vehicle starter.

### BACKGROUND OF THE INVENTION

The present invention protective device, system of an electrical card include an electrical circuits and technological components and method of wiring, installing and locating such device and system to some solenoid designated to protect and control the vehicle starter operation of some motorized automobile solenoid outgoing and ingoing electric connections and components, wherein, these are designated and are in the field of preventing vehicles theft and preventing the use of a motorized vehicles by an unauthorized person.

Wherein, the present invention concentrates mainly on solution regarding the solenoid section of motor-vehicle, the present invention herein, will explain to the One Skilled in the Art, in some focused manner, such section of “solenoid” in some vehicle. Wherein, solenoid is one of the main devices which pre-engaged starter, enabled, controlled and moved by such solenoid of the motorized vehicle;

To make an engine start it must be turned at some speed, so that it sucks fuel and air into the cylinders, and compresses it. The powerful electric starter motor does the turning. Its shaft carries a small pinion (gear wheel) which engages with a large gear ring around the rim of the engine flywheel. In a front-engine layout, the starter is mounted low down near the back of the engine.

The starter needs a heavy electric current, which it draws through thick wires from the electric battery of the vehicle. an ordinary hand-operated switch could not switch it on: it needs a large switch to handle the high current. The switch has to be turned on and off very quickly to avoid dangerous, damaging sparking. So a solenoid is used—an arrangement where a small switch turns on an electromagnet to complete the circuit.

The starter switch in the vehicle is usually worked by the ignition key. Turn the key beyond the “ignition on” position to feed current to the solenoid.

The ignition switch has a return spring, so that as soon as the user release the key it springs back and turns the starter switch off. When the switch feeds current to the solenoid, the electromagnet attracts an iron rod. The movement of the rod closes two heavy contacts, completing the circuit from the battery to the starter. The rod also has a return spring —when the ignition switch stops feeding current to the solenoid, the contacts open and the starter motor stops. Wherein, the return springs are needed because the starter motor must not turn more than it has to in order to start the engine. The reason is partly that the starter uses a lot of electricity, which quickly runs down the battery. Also, if the engine starts and the starter motor stays engaged, the engine will spin the starter so fast that it may be badly damaged.

There's more to a car starter system: As well as switching on the motor, the solenoid also slides the pinion along the shaft to engage it. The starter motor is saved from over-speeding when the engine starts by means of a free-wheel clutch, like the free-wheel of a bicycle. The return spring of the solenoid withdraws the pinion from engagement.

Wherein, as the solenoid is a small device that acts a major influence on the operation of a motor vehicle, and as it can be spots, therefore, without such solenoid sections that are visible and can be used with no protection by any users, the operation of some motorized vehicle are very difficult for users, and especially to those who are not authorized to use such vehicles. Thereof the present invention sees the “solenoid” as a device that can be protected from one hand, and can be used differently and more protectively, by bypass system.

Some goals of the present invention achieved, in one implementation of the present invention by the present invention protective box device, a protective cover designed to enabled to locked and secured of some of its sections.

such device of the present invention, are to be connected to some section of the solenoid for the purposes of preventing access to some of such solenoid electric connections that are to be connected to the vehicle starter, and, to enable different way of control on such solenoid electric connections.

Furthermore, such device including some system of the present invention, designated to be accommodate in its hollowed internal section. Such system includes an electrical card include an electrical circuits and technological components that enabling an electric bypass circuits that neutralizing the direct connection between the electric circuits of the solenoid and the vehicle switch.

wherein, an extension of some of the electric connections of the solenoid and to such solenoid existing in prior-art are made and extended in the present invention to the inner hollowed section of such protective device, to the electrical card, and in the device the electrical card designated with an electric circuits that include some electric bypass that enables connecting or disconnecting, “on” and “off” connections, of the electric circuits between such solenoid to the vehicle switch, which controls the starter operation.

Wherein, such bypass of “on” and “off” connections operates in the electronic card and the electric circuits and components of the system of the present invention by some implementations of the present invention, such as by wired coded keyboard; by electrically coded remote-control technological components that are controlled from the outside by devices and system signals; by Cellular Sim operates by authorized telephone number, by telephone call; by Satellite controlled software.

wherein, in some implementation of the present invention, on the outside of the present invention protective device are electrical connections, that when the some signal closing or opening the electric circuits of some electric circuits that is located in the protective device the switch ignition is enabled or disabled to operates by the user.

In another implementation of the present invention, the present invention enabling the hosing and the securing of the present invention system, the electric card and circuits and components of the present invention system, in the solenoid box inner hollowed section, inside the solenoid container itself that is adapted to soch extra accommodations of the system sections.

Today, in most immobilizer devices embedded in motorized vehicles, that are objective is to enable the prevention of breaking into vehicles, as well as enabling locating the geographic location of some vehicles, the possibility of neutralizes the immobilizer is relatively simple and fast to operates. Therefore, it is accessible to nun-authorized persons, for example, to a burglar whose objective is to steal vehicles.

Wherein, therefore it is possible to nun-authorized persons to perform an electrical bypass to the immobilizer devices, and neutralized such immobilizer devices. It is only one example, of one of the actions enabling to neutralize some immobilizer devices, and so preventing it from performing its objective and its purpose. This provides a solution to a thief when for example stealing the vehicle or in the eventuality that the immobilizer system becomes faulty. Thus, the objective of the prevention of theft by an expert who is determined to steal the vehicle is not attained at all.

The advantages of the device and system according to the method of this present invention, in contrast to existing immobilizer devices, are principally that in the method of implementation of this present invention, its location is mostly inaccessible.

The method of the system is that one or more authorized persons, for example, have access to the code numbers entered on the cellular system's chip, for example, which is inside the enclosed container device and system. Vehicle potential thief of various types will have to take into account the time needed to dismantle such device and systems, and thus the theft will not be a practical matter to undertake.

Additional advantages of this method are that in the implementation of the cellular operation, for example, the technology sets up a control system with a coding having a very great number of possibilities, and thus, the control system cannot be unlock.

### SUMMARY OF THE INVENTION

It is to be understood that both the foregoing general description and the following detailed description present embodiments of the invention and are intended to provide an overview or framework for understanding the nature and character of the invention as it is claimed. The accompanying drawings are included to provide a further understanding of the invention and are incorporated into and constitute a part of this specification. The drawings illustrate various embodiments of the invention and, together with the description, serve to explain the principles and operations of the invention but not to limit the invention to these descriptions only.

Method, system and device of protecting device fitting by shape and by its sections to close and lock the access to some of the solenoid electric connections that are needed for the vehicle starter operation;

Wherein, the protecting closing device of the present invention, enables in one implementation of the present invention by device which includes two sections, first section of the box device designated to be connected securely to some section of the solenoid, wherein, such section of the box device is constructed in such shape and a way that enables to close and hide some sections of such solenoid, and furthermore, to enables some openings in the box device section to allows some passage of some components and electric connections and electric wirings that are going out of such solenoid, enabling them to pass into some hollowed section of such box section.

Wherein, the second section of the box device designated to be connected securely to the first section that has been secured to some section of the solenoid, wherein, by closing securely such second section of the box device to the first section of the box device, for example, the second section box device that comes after the first section box device—enters the first section box device—closed and secured for example by 2 clips getting into gaps, or by nitts with no screwing head; or by coded mechanical mechanism of coded numbers like used in some safe box; or by digital, or electrical lock; all are example of closing means and are not a closed list.

Wherein, the structure of the box device shape enables some hollowed space inside the box device installation between the device two sections.

However, closing the second section to the first section of the box device, is to be executed only after installing the present invention electrical card inside the hollow section of the box device and only after connecting it to some of the electrical connections and to some outgoing elements of the solenoid; Wherein, the present invention electrical card includes some electrical circuits enables electrical bypass that designated to control the solenoid operation. However, closing and securing the second section to the first section of the box device enabling the present invention purpose to enable the operation of the solenoid from the electrical card secured in the inside sections of the box device.

Wherein, the second section of the box device has some openings, wiring and connections in the box device section that allows some passage of some components and electric connections and electric wirings that are going out of such electric card of the present invention and solenoid, for the purpose of connecting them to some of the vehicle elements as will be explained.

Wherein, second section of the box device designated to be connected securely to the first section of the box device by connecting means, in such a manner that hides and protect the first section of the box and its connections and closing means to the solenoid and box device from unauthorized persons.

Wherein, the structure of the closure of the box device of the present invention on the solenoid and the starter of some motorized vehicle is not possible due to the location of the solenoid and the starter inside the vehicle and the density of other components of the vehicle in its vicinity. Therefore, the opening and the closing of such box device enabled and possible only in time and conditions when the solenoid and the starter are been taken out of the vehicle, only by removing the starter and the solenoid outside the vehicle in an external treatment surrounding of a licensed garage.

Wherein, the electrical card and electrical wiring and connections in one implementation of the present invention are to be described as flows:

The first section of the closing box device of the present invention is to be closed and secured for example to the two screws of the solenoid current flow.

Therefore, the shape of such first section of the closing box device designated is to be with some openings suitable for this purpose. Furthermore, an opening pass are to be enabled, such opening that is suitable for example to enable the pass of the electrical wiring going out of the solenoid designated to be connected to the vehicle switch; wherein, such electrical wiring are to be controlled by the electrical card of the present invention bypass electrical circuits.

The second section of the closing box device of the present invention electrical wiring, connections and openings, that are connected to the electrical card and electrical wiring of the present invention and to some of the vehicle components and electric wiring, are as fallowed for example:

In the second section box device, are to be some hole designated for the screw extension made by the present invention to some screw that going out from the solenoid, such extension made to enables such screw connection to the vehicle electrical battery.

In the second section box device, are to be some electrical connectors and wirings:
first voltage input from the vehicle switch—transferring current to micro-card. (When micro-card does not receiving current X time its disconnects the system)

Second voltage input designated to some wiring coming from the vehicle switch. The second voltage input turns on the solenoid, giving it electric power that activates the vehicle starter.

Connector to enable some connection of wiring to constant voltage, designated to enable some constant voltage to the electrical card of the present invention. 12 volts for example, such as getting such constant voltage from the screw extended.

Connector to enable some grounding connections.

Connector to enable connection and wiring to keyboard enabling the control of opening or closing the bypass electrical circuits of the present invention electric card and circuits operation by coded in some of the present invention implementations that are wired solutions and not remote-operation implementations that enabled in the present invention, such as electrically coded remote-control; SIM cellular operated; satellite operated.

Wherein, another implementation of the present invention enabling such system of the present invention, including electrical card and electrical circuits and components of the present invention to be accommodate in the original solenoid box in some suitable hollowed inner section adapted and fitted for the present invention purposes.

Wherein, the inner sections of such device, inside its hollowed box section, are secured and undetectable, where such device covers and protects some sections of such solenoid electric connections hides in it and prevent access to the switch connector.

Wherein, such device include in its inner sections, an extension connections from the solenoid electric connections and to the solenoid electric connections, and in the device box located the present invention electric card and electric circuits and component allowing the present invention purposes.

Wherein, in such device box located some bypass electric circuits and electronic system—that allows by designated electric system to makes a electric bypass circuit between the solenoid connections and the vehicle starter—all are disclosed in the present invention, designated to enables by wiring coded components or by some remote control operation and components enables remote signal to open or cluses such electric circutes of the present invention enabling to control the solenoid operation to control the vehicle starter operation, for example, by wiring coded components such as by connecting to some coded keyboard located at the vehicle driver surrounding, or by remote control operation such as by cellular signal from cellular telephone, to the electronic card and in one implementation of it to its cellular SIM in the electronic card of the present invention.

Wherein, the object of the method, system and device of the present invention, is to preventing the theft and use of a motorized vehicle by an unauthorized person. This goals achieved by a method, system, and device in the present invention, which connecting cover locked protective container, the device box of the present invention, on some sections of the solenoid electric connections, including in it a system enabling bypass circuit that neutralizing the connection between the switch of the solenoid to the vehicle driver switch controlling the operation of the solenoid to operates the vehicle starter—making an extension of the electric connection of the solenoid to the inner parts of the device, and in the device electric circuit located some electric circuits bypass of on/off connection of the circuit—an on/off bypass electric circuit between the solenoid and the vehicle starter—wherein, such bypass electric circuits operated controled by designated technological component installed on the electronic card and by remote-control signal of some outside devices and system that controls such technological component located on the electric card. Wherein, such devices and system connecting such technological component by wiring or by remote-controlled signals. Operating the solenoid enabling to operates the vehicle starter.

The system and method enable the protection and concealment of the system in the device, which are in this present invention, inside a protective box device, container device, fitted in shape to be connected to some section of some solenoid. The device and the system in it, built in such a manner that make it not possible for an unauthorized user to easily access them.

Such device for immobilizing a vehicle is in a way that is not obvious to the potential thief that the vehicle is immobilized. Wherein, such immobilizer can only be operated by a person who in his possession is an electrically coded, wiring or remote-control. Wherein, such method, system and device of immobilizer solenoid and thereof starter, comprises, a device having some shape fitted to cover and hide at-list part of the solenoid electric connections, and especially the connection to the vehicle switch; wherein, such device having in it connecting means fitted to be connected to the solenoid electric connections input and output and to some of the vehicle elements and components needed to enable the present invention goals, however yet, some of the solenoid electric connections are not to be detachable from the outer side of the covering device.

wherein, the system in the device of the present invention, enabling an “off” and “one” control operations over the electric circuits and connection by the electronic card which operates by wiring or by remote-control signal or cods, enabling to open or closed some electric circuits; wherein, electric circuits inside the covering device inner protective hollowed section, is the replaceable area and circuits and system that replace the usual ordinary common Prior-Art connection from and to the solenoid.

### BRIEF DESCRIPTION OF THE DRAWINGS

The accompanying drawings are included in this present patent application with the objective of supplying a greater understanding of the invention, and are included as an integral part of this patent. The drawings illustrate different embodiments of the invention and, together with the description, serve the purpose of explaining the principles of operation of the invention; all by way of example only, and not with the objective of limiting the invention to these descriptions exclusively.

The enclosed drawings:

1. Drawing labelled as Drawing No 1 of the method, system and protective device including some electrical card and the electric circuits and components of the present invention, represents one implementation of the present invention illustrates the box closing protective device and its sections designated to close some sections of the solenoid located on the starter of some motorized vehicles, fitted to cover, hide and protect some of the solenoid electric connections, designated to control the operations of the solenoid and the starter of some vehicle operation by authorized person from the outside of the solenoid surrounding.

2. Drawing labelled as Drawing No2 of the method, system and protective device including some electrical card and the electric circuits and components of the present invention, represents one implementation of the present invention illustrates for better understanding the box closing protective device and its sections as in the present invention that closes some sections of the solenoid that located on the starter of motorized vehicles, fitted to cover, hide and protect solenoid electric connections, designated to control the operations of the solenoid and the starter of some vehicle operation.

3. Drawing labelled as Drawing No3 of the method, system and protective device including some electrical card and the electric circuits and components of the present invention, represents one implementation of the present invention illustrates for better understanding some components and electric wiring in some section of the box device and of some electric card of the present invention which are located and closed protectively at the box closing device of the present invention.

4. Drawing labelled as Drawing No 4 of the method, system, device illustrate another implementation of the present invention, wherein furthermore, another implementation of the present invention enables, with some necessary changes and adjustments, such system of the present invention including such electric card, electric wires and technological components and some extension of components, to be located and accommodate inside the solenoid covering box itself.

5. Drawing labelled as Drawing No 5 of the method, system, device illustrate another implementation of the present invention, wherein furthermore, herein attached another illustration to better understanding of the implementation of FIG. 4 herein of the present invention.

6. Drawing labelled as Drawing No 6 of the method, system, device including some electrical card and the electric circuits and components of the present invention, represents one implementation of the present invention illustrates for better understanding some components and electric wiring in some section of the box device and of some electric card of the present invention which are located and closed protectively at the box closing device of the present invention.

7. Drawing labelled as Drawing No 7 of the method, system, device including some electrical card and the electric circuits and components of the present invention, represents one implementation of the present invention illustrates some electric circuits and components that enable some of the present invention goals in some implementation of the present invention.

8. Drawing labelled as Drawing No 8 of the method, system, device including some electrical card and the electric circuits and components of the present invention, illustrates some electric circuits and components of Drawing No 7 herein, for better understanding and in more details.

9. Drawing labelled as Drawing No 9 of the method, system, device including some electrical card and the electric circuits and components of the present invention, illustrates some more electric circuits and components of Drawing No 7 herein, for better understanding and in more details.

10. Drawing labelled as Drawing No 10 of the method, system, device including some electrical card and the electric circuits and components of the present invention, illustrates furthermore some electric circuits and components of Drawing No 7 herein, for better understanding and in more details.

11. Drawing labelled as Drawing No 11 of the method, system, device including some electrical card and the electric circuits and components of the present invention, illustrates furthermore some electric circuits and components of Drawing No 7 herein, for better understanding and in more details.

12. Drawing labelled as Drawing No 12 of the method, system, device including some electrical card and the electric circuits and components of the present invention, illustrates furthermore some electric circuits and components of Drawing No 7 herein, for better understanding and in more details.

13. Drawing labelled as Drawing No 13 of the method, system, device including some electrical card and the electric circuits and components of the present invention, illustrates furthermore some electric circuits and components of Drawing No 7 herein, for better understanding and in more details.

14. Drawing labelled as Drawing No 14 of the method, system, device including some electrical card and the electric circuits and components of the present invention, illustrates furthermore some electric circuits and components herein that enables to combine some technological component in the present invention system, such as Cellular SIM to control by remote-control the operation of the present invention system and electric circuits.

15. Drawing labelled as Drawing No 15 of the method, system and device of the present invention, represents another implementation of the present invention enabling to connect some coded controlling device near the driver, enabling connection between the keyboard section by coded and between some electric card of the present invention, to enable control on the solenoids. Wherein, such implementation enabling to open and close the ignition of some motorized vehicle. Wherein, such implementation enabled in a wire, or in wireless implementation. Such implementation, seem to be less expensive implementation.

### DESCRIPTION OF THE PREFERRED EMBODIMENTS

The description of the drawings of this appendix, and the drawings to which they refer, are included in this present patent request with the objective of providing a greater understanding of the invention, and are included and form part of this patent. The description of the drawings provide a more detailed description of different embodiments of the invention, and together with the drawings and the other parts of the patent application document, serve the purpose of explaining the principles and the method of operation of the invention; all this only by way of example, and not with the objective of limiting the invention to these descriptions exclusively.

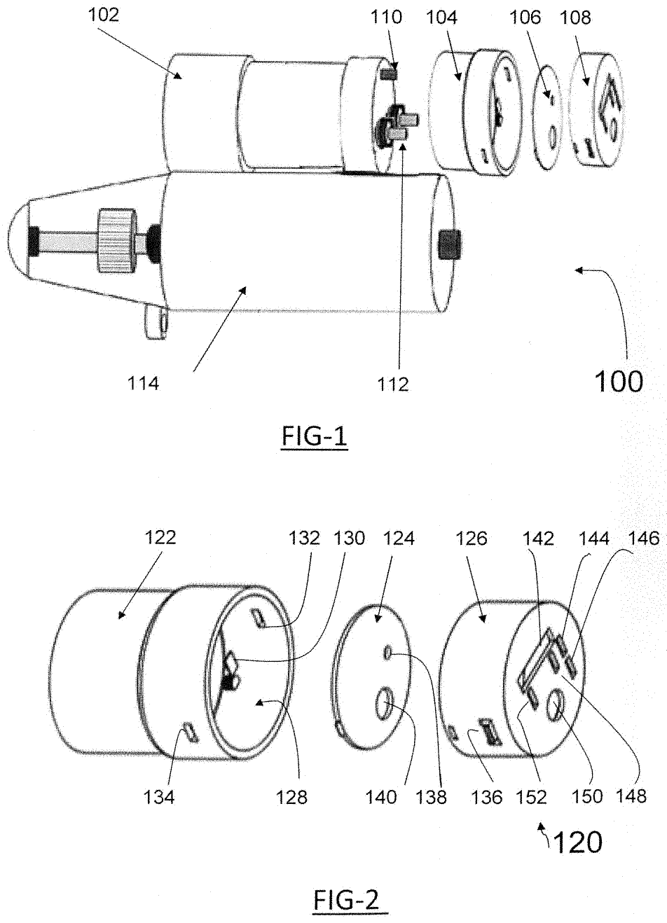

FIG. 1 of the present invention represents implementation of the present invention as an example only, wherein, solenoid 102 represent the common existing solenoid, wherein, electric wiring connection 110 on the outside section box of the solenoid 102, is the vehicle switch connection, and is openly visible and exposed to anyone who opens the hood of a motor vehicle, this is the situation in the Prior-Art. Wherein, screw 112, which receives direct voltage from the battery, and a screw of “ground” to electricity next to it, are also exposed to all. A person who is not authorized and has malicious intentions can open the bonnet and move the vehicle just by the contact and connecting by conducts electricity element between these sections.

Thereof, the present invention enables to close, protect and lock the electric wiring connection to the switch 110, by connecting and closing section 104 of the present invention box device on the solenoid 102 external section by connecting means, in a way that hide in some of its hollowed inner section the electric wiring connection to the switch 110.

Wherein, in one implementation of the present invention such connecting means enabled by the solenoid 102 external screws 112 and screw of ground sections. Where, the section 104 of the box device is pre-fix with holes that enable such screws to pass through section 104 and to be secured from the inner hollowed section 104.

Wherein, another section of the present invention box device, the electric card 106, is placed in the inner hollowed section 104, where, the electric wiring connection to to the switch 110 is connected to the electric card 106 electric circuits and components output from solenoid 102, and also electric card 106 wired and connected to electrics connectors leading to some outer part of closer section 108.

Wherein, closer section 108 fitted to be fixed, closed and lock hollowed section of section 104 of the present invention box device of the present invention box device, in such a way that when starter 114, with solenoid 102 located on top of it, and with the present invention box device sections 104, 106 and 108 fixed to solenoid 102, when those fixed together before placing inside the vehicle, some malicious users cannot operate the starter even if the hood is open, and there is no possibility of opening the box device 104, 106 and 108 of the current invention, apart from removing all the said systems outside the vehicle and handling them in the garage.

Thereof, a bypass circuits on the electric card 106, enables just for licensed to use to operate the solenoid 102 and the starter 114, by some different alternative technological implements enabled such bypass circuit to connect or disconnect the switch of the vehicle from the solenoid 102, as in the present invention, all by a wired or wireless activation of codes or technologies.

FIG. 2 of the method, system, device and the electrical card and the electric circuits and components of the present invention, represents one implementation 120 of the present invention illustrates for better understanding the box closing device 120 and its sections as in the present invention that closes some sections of the solenoid located on the starter of some motorized vehicles, fitted to cover, hide and protect solenoid electric connections, designated to control the operations of the solenoid and the starter of some vehicle operation by some authorized persons.

Wherein, the method, system and device of protecting device fitting by shape and by its sections 122, 124 and 126 to close and lock the access to some of the solenoid electric connections that are needed for the vehicle starter operation;

Wherein, the protecting closing device 120 of the present invention, enables in one implementation of the present invention by device which includes two main sections, first section 122 of the box device designated to be connected securely to some section of the solenoid, wherein, such section of the box device is constructed in such shape and a way that enables to close and hide some sections of such solenoid, and furthermore, to enables some hollowed space 128 in the box device section 122 to allows some passage of some components and electric connections and electric wirings that are going out of such solenoid, such as of the switch wiring and connection, and some screws (screw 112 of FIG. 1) located on the solenoid outer box enabling them to pass through the device box 120 sections, into some hollowed section 128 of such box section 122. Wherein, such switch wiring and connection has an extension for wiring and connector 130, enable to extend it through the hollowed section of section 122, and through the electronic card 124 through prefixed hole 138, and furthermore, to be extent through section 126 and pass through and to be wired to an electric connector at prefixed opening 152 section. Similar solution made to such screws with an extension, and prefix passage ways through some hollowed section 128 of such box section 122, and through the electronic card 124 through prefixed hole 140, and furthermore, to be extent to outer section 126 through fitted hole 150.

Wherein, the second section 126 of the box device 120 designated to be connected securely to the first section 122 that had been secured before to some section of the solenoid, wherein, by closing securely such second section 126 of the box device 120 to the first section 120 of the box device 120, for example, the second section 126 box device that comes after the first section 122 box device—enters the first section 122 box device—closed and secured for example by clips 136 getting into gaps 132 and 134, or by nitts with no screwing head for example; or by coded mechanical mechanism of coded numbers like is used in some safe box; or by digital, or electrical lock; all are example of closing means and are not a closed list.

Wherein, the structure of the box device shape enables some hollowed space inside the box device installation between the device two sections 112 and 126.

However, closing the second section 126 to the first section 122 of the box device 120, is to be executed only after installing the present invention electrical card 124 inside the hollow section 128 of the box device 122 and only after fixing or connecting some electrical wiring and connectors between the electric card 124 electric circuit and component to the prefixed sections 142, 144, 146, 148 and sections 152 and 150 mentioned, designated to enable some outgoing and ingoing electric wiring and elements of and to the electric card 124 and solenoid; Wherein, the present invention electrical card 124 includes some electrical circuits enables electrical bypass that designated to control the solenoid operation and prevent the use from unauthorized users.

However, closing and securing the second section 126 to the first section 126 of the box device enabling the present invention purpose to enable the operation of the solenoid from the electrical card 124 that is secured in the inside sections of the present invention box device.

Wherein, second section 126 of the box device designated to be connected securely to the first section 122 of the box device by connecting means, in such a manner that hides and protect the first section 122 of the box and its connections and closing means to the solenoid and solenoid box device from unauthorized persons.

Wherein, the structure of the closure of the box device of the present invention on the solenoid and the starter of some motorized vehicle is not possible due to the location of the solenoid and the starter inside the vehicle and the density of other components of the vehicle in its vicinity. Therefore, the opening and the closing of such box device 120 enabled and possible only in time and conditions when the solenoid and the starter are been taken out of the vehicle, only by removing the starter and the solenoid outside the vehicle in an external treatment surrounding of a licensed garage.

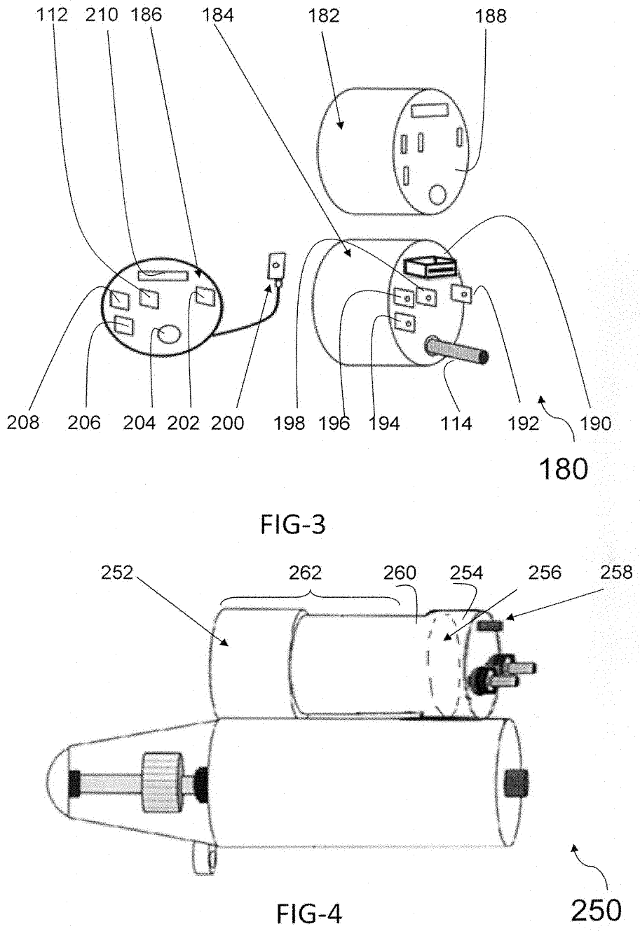

FIG. 3 of the method, system of an electrical card and the electric circuits and components, and protective device of the present invention, represents one implementation 180 of the present invention illustrates for better understanding the system components and electric wiring in some section of the box device and of the electric card of the present invention which locates and closed protectively at the box closing device of the present invention.

Wherein, the device closing section 182, 184 (such device second section 126 in FIG. 2) of the box device of the present invention has some openings, designated for wiring and connections placing in such box device section, illustrates herein it two condition, one illustrates the closing section only with the opening holes prefixed in such closing section 182, before installing the wiring and electric connectors, and the second illustrates of the same closing section 184 is after installing the wires and electric connectors and components on the device closing section 188.

Wherein, locating some components and electric connections and electric wirings from and to the electrical card 186 and to the some sections of the solenoid are for the purpose of connecting them to some of the vehicle elements to enable the secured operation of the solenoid and the starter of some vehicle.

The second section 182, 184 of the closing box device (“second section” 126 in FIG. 2) of the present invention illustrates electrical wiring, connectors and components illustrates on illustration 182 and such section 182 only with such opening holes illustrates on illustration 184 designated for connectors and components, that are connected to the solenoid and to the system of the present invention, electrical card 186 and electric circuits and component from one side, connected to electrical wiring and connectors 190, 192, 194, 196 and 198 of the present invention and from second side are to be connected to some of the vehicle components and electrical wiring. Wherein, such connectors are these, as fallowed for example:

In the box device section 184, are to be some hole designated for the screw extension 114 made by the present invention to some screw that going out from the solenoid, such extension made to enables such screw 114 direct connection to the vehicle electrical battery.

In such second section box device, are to be some electrical connectors and wirings:

First connector input 198 designated to get some constant voltage 12 volts for example, such as getting such constant voltage from the extended screw 114. Such connector 198 designated to enable some connection of wiring to constant voltage, designated to enable some constant voltage to the electrical card 186 of the present invention.

Another connector 194 input from the vehicle switch—transferring current to some micro-card. (When micro-card does not receiving current for X period of time it disconnects the system).

Wherein, some voltage input connector 192 designated to some electric wiring coming from the vehicle switch. This second voltage input turns on the solenoid, giving it electric power that activates the vehicle starter.

Wherein, another electric connector 196 designated to enable some grounding for electric connections.

Wherein, another connector 190 designated to enable connection and electric wiring to some implementations of the present invention that designated to enables to wired devices and systems that activates and control the opening and closing of the electric bypass of the present invention, such as wiring to some coded keyboard, enabling the control of opening or closing such bypass electrical circuits of the present invention electric card and circuits operation by entering some coded sequence of numbers as an example on a keyboard connected to a code recognition system, in some of the present invention implementations that are wired solutions and not remote-operation implementations that are enabled too in the present invention, such as electrically coded remote-control; SIM cellular operated; satellite control and operated.

Wherein, section 186 illustrates the system electric card 186 and electric circuits and components of the present invention, illustrates the electric connections and holes pass for to the connectors, wherein, In accordance with the order of recording herein, the elements on section 184 fitted to the holes and to the connectors on the electric card 186, in this order and just for the purpose of example, connectors or holes at section 186 electric card, 202, 204, 206, 208, 210′ and 2012 are fitted to sections and connectors 192, 114, 194, 196, 190 and 198. Wherein, connector 200 illustrated on section i86, is an electric wire extension and connector designated to be connected to the switch connector located on the surface covering box of the solenoid.

FIG. 4 of the method, system, device illustrate another implementation 250 of the present invention, wherein furthermore, such another implementation 250 of the present invention enables, with some necessary changes and adjustments, such system of the present invention and the goals of the present invention, including such electric card, electric wires and technological components and some extension of some components, to be located and accommodate inside the solenoid original covering protective box itself. Wherein, in such implementation 250 of the present invention, the covering box of some solenoid 252 are to be pre-fitted and may need some adjustment such as to enlarge such box to large, biger, or higher extents more than in the solenoid box illustrated in FIG. 1 section 102, to enable sufficient extra hollowed inner space in such solenoid, for example an extra hollowed inner space to enable the accommodation of the electric card 256 and another space 260 and 254 to enable to connect such electric card 256 to extension component and circuits wiring and connectors, such extra hollowed inner space to enable the accommodation of such extra sections of the system of the present invention in it.

For example sections 254, 260 and 256 of the solenoid box are adjusted in such manner that enables to accommodate the system sections of the present invention, illustrates for example for better understanding the electric card 256 of the system of the present invention, illustrates by “dotted lines” that symbolize the location of such electric card 256 in the inner section of such solenoid 252, located within the closed box 252 of the solenoid. Wherein, the location of the electric card 256 in the solenoid box 252 is the end border of the solenoid box illustrates in FIG. 1 section 102, which can be seen immediately that its space borders are at space 262. Wherein;

In such implementation 250, when outer devices and system controlling by remote-control technologies such as by wired coded keyboard; by electrically coded remote-control technological components that are controlled from the outside by devices and system signals; by Cellular Sim operates by authorized telephone number, by telephone call; by Satellite controlled software.

the opening and the closing of the present invention electric bypass is by controlling some technological components installed in the system of the present invention, some of the present invention wiring extension and of electric wires to some controls devices and system are not required, and mainly the connector 158 designated to be wired to the vehicle switch can be sufficient with screws conducting electric voltage are to enable the present invention goals and operation the solenoid 252 and the starter in accordance with such goals, as seen in the present FIG. 4 illustration. However, one skilled in the art should know that the present implementation can be performed optionally by wires connection between different components as well.

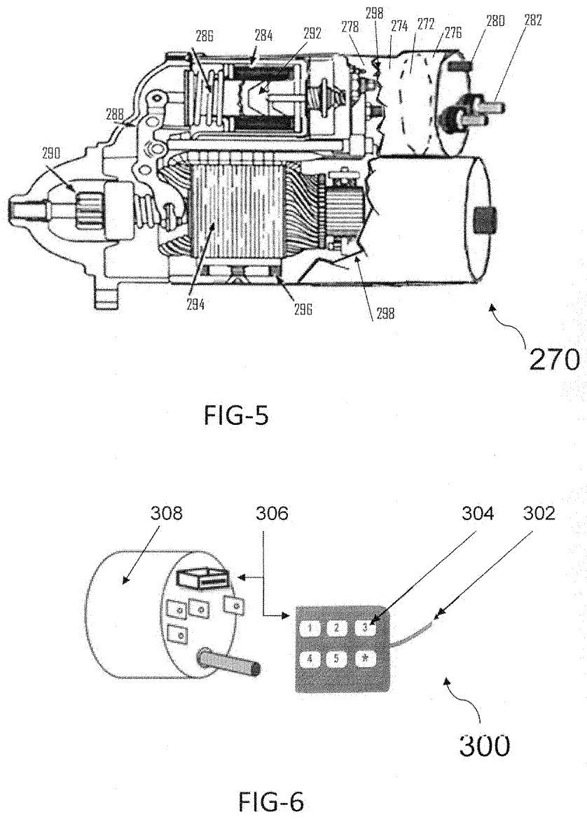

FIG. 5 of the method, system, device of the present invention, illustrate another implementation 270 of the present invention, wherein furthermore, herein attached another illustration 270 for better understanding of the implementation of FIG. 4 herein at the present invention. Wherein, the system, the components and some electric circuits and electric card of the present invention installed inside the case that accommodates the solenoid device sections that mounted on the vehicle starter device as seen herein in illustration 270. Wherein, section 284 illustrate the solenoid, section 286 illustrates the return spring, section 292 illustrate the plunger, enabled the shift fork section 288 operation towards the starter drive gear. Wherein, section 294 represent the armature and section 296 represent some filed coils of the starter unite.

Wherein, FIG. 5 herein, describes the starter unite with some of its case cover that was removed in the crop area marked 298, for better understanding the inside of some of the sections of the starter described herein. Wherein, similar to this description, the upper section of the illustration, the solenoid, mounted on the starter section is also describes the solenoid unite, wherein, some of the solenoid case cover was also removed in the crop area marked 298, for better understanding of the new division of the solenoid components together with the present invention sections that were added and all stored in the new adapted cover box container of such solenoid.

Wherein, one can see that the conventional solenoid sections occupying only part of the inner volume of the present new enlarged solenoid covering box, in the current application. When the coverage area is increased so that the parts of the system and components of the current invention can be stored within the inner area of such solenoid new increased storage box together with the solenoid conventional sections.

Wherein, one skilled in the art can see that most of the solenoid conventional sections occupied the internal area of the storage box up to area marking 278, wherein, the section from area marking 278, including increased storage box 274 and 276 to the outer section of such solenoid cover box enabling some extensions of some components 280 such as extension of electric connection designated to the vehicle switch, and extension of some screws such as to connect direct cornet 282. This enabled by an extra solenoid new increased storage box designated to accommodates some of the present invention system, electric card 272 and electric circuits and component of the present invention.

FIG. 6 of the method, system, and device of the present invention illustrate another implementation 300 of the present invention, wherein furthermore, such another implementation 300 of the present invention enables some control on some of the system component and electric circuits wired to the connectors located at protective device closing box 308 by a keyboard coded 304 device and system wired circuits connection 302 that designated to be connected to the connector 306 as in one implementation of the present invention.

Wherein, connecting some coded controlling device 304 near the driver, enabling to control between the coded device to some of the present system sections. Such implementation, enabling to open and to close the abilities of ignition of some vehicles solenoid and starter by present invention sections installed in. Wherein, such implementation enabled in a wire and in wireless implementations. Such implementation, seem to be less expensive implementation.

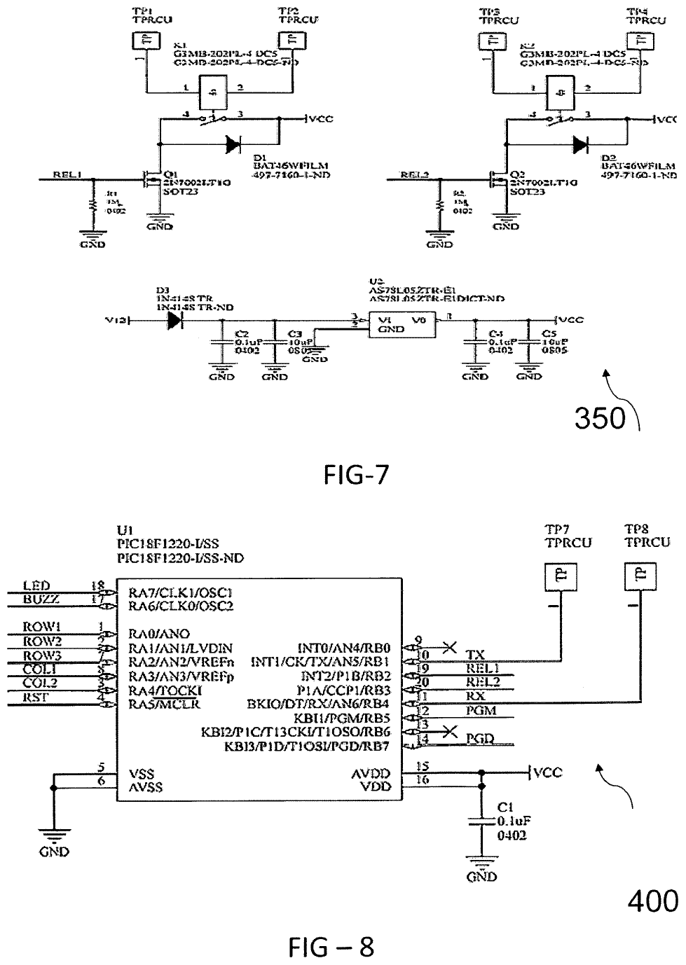

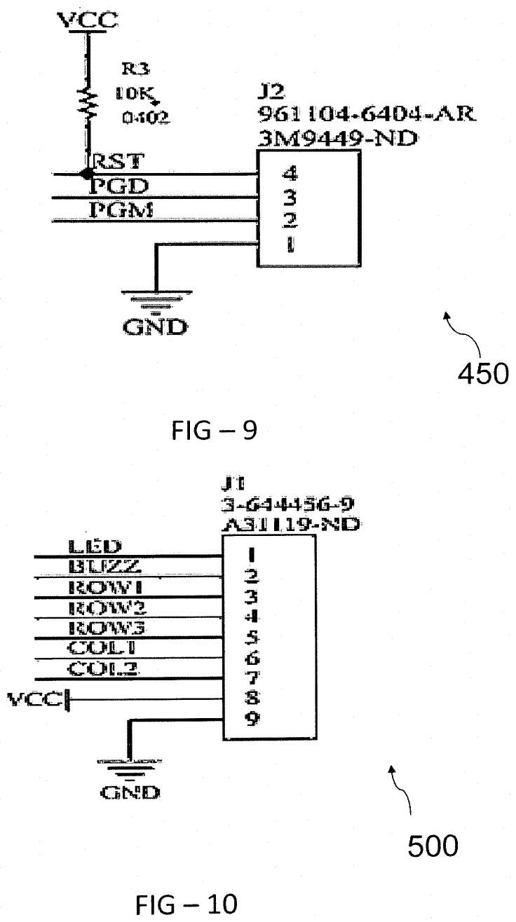

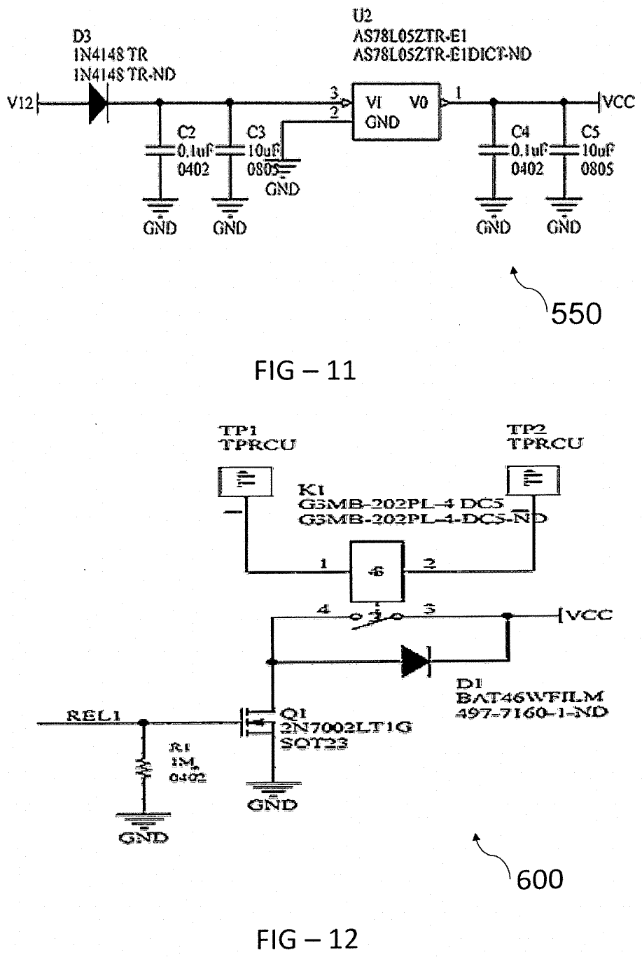

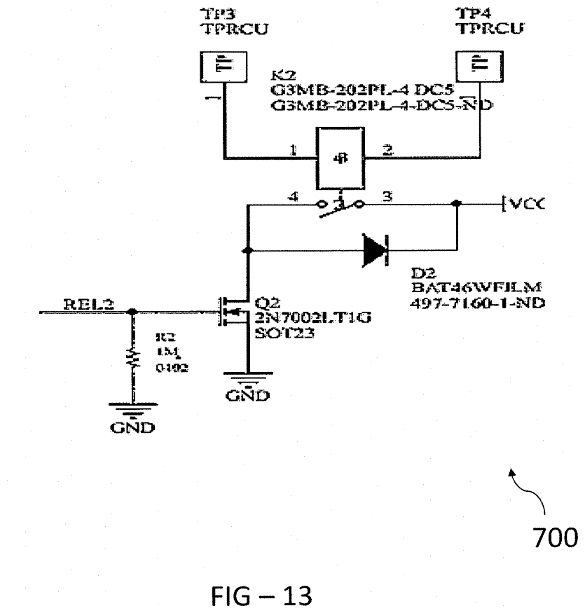

FIG. 7 of the method, system, device of the present invention, represents an example of one implementation 350 of the present invention illustrates some electric circuits and components 350 that enables the operation of such method, device and system as in some implementation of the present invention, wherein, such electric circuits and components 350 of FIG. 7 herein, are detailed described in FIG. 8, FIG. 9, FIG. 10, FIG. 11, FIG. 12, and FIG. 13 herein, in the present invention.

FIG. 8 of the method, system, device include the electrical card and the electric circuits and components of the present invention, illustrates some electric circuits and components 400 that are one section and one part of the circuits and components illustrates in Drawing No 7 herein, for better understanding and in more details. Wherein, such electric circuits and components 400 illustrate details of the electric circuit and description of its section of some Processor Electric Circuit, wherein 1. The 1U processor functions to process the various signals and send signals respectively. 2. A stability wire due to the processor manufacturer's recommendation. 3. Leg 18 enables the connecting of the processor to an LED circuit. 4. Leg 17 enables the connecting of the processor to the horn circuit. 5. Legs 1, 2 and 7 connecting the processor to some external keyboard lines. 6. Legs 3 and 8 connect the processor to the external keyboard columns. 7. Legs 12, 4 and 14 connecting the processor to some burn software. 8. Leg 9—No connection. 9. Legs 10 and 11 are optional connection to external communication. 10. Legs 19 and 20 connecting the processor to the relay circuits.

FIG. 9 of the method, system, device include the electrical card and the electric circuits and components of the present invention, illustrates some electric circuits and components 450 that are one section and one part of the circuits and components illustrates Drawing No 7 herein, for better understanding and in more details, illustrates the Processor connection electric circuit to the software burner.

FIG. 10 of the method, system, device include the electrical card and the electric circuits and components of the present invention, illustrates some electric circuits and components 500 that are one section and one part of the circuits and components illustrates Drawing No 7 herein, for better understanding and in more details, wherein, such electric circuits and components 500 illustrates details of the electric circuit and description of its section of some dedicated circuit to connect the processor to an external keyboard.

FIG. 11 of the method, system, device include the electrical card and the electric circuits and components of the present invention, illustrates some electric circuits and components 550 that are one section and one part of the circuits and components illustrates Drawing No 7 herein, for better understanding and in more details, wherein, such electric circuits and components 550 illustrates details of the electric circuit and description of its section of some V12 external power circuit for V5 processor voltage, wherein 1. 2U Voltage stabilizer V5. 2. 5C, 4C, 3C and 2C are voltage stabilizing and noise filtering cables according to manufacturer's recommendation. 3. 3D is some diode to prevent reverse current. 4. VCC indicates that V5 is stabilized to the inner circuit. 5. 12V external power supply.

FIG. 12 of the method, system, device include the electrical card and the electric circuits and components of the present invention, illustrates some electric circuits and components 600 that are one section and one part of the circuits and components illustrates Drawing No 7 herein, for better understanding and in more details, wherein, such electric circuits and components 600 illustrates details of the electric circuit and description of its section of some Circuits relay activation, wherein: 1. 1D diode reverse “current protection”-“height voltage”, when disconnecting relay. 1. 2K relay for transmitting external battery voltage. 1. 3R, 1Q A voltage transfer circuit from the processor to operate the relay without loading the processor.

FIG. 13 of the method, system, device include the electrical card and the electric circuits and components of the present invention, illustrates some electric circuits and components 700 that are one section and one part of the circuits and components illustrates Drawing No 7 herein, for better understanding and in more details, wherein, such electric circuits and components 600 illustrates details of the electric circuit and description of its section of some Circuits relay 2 operation, wherein: 2. 1D diode protection of the “inverted current”/“height voltage” while disconnecting the relay. 2. 2K relay for transmitting external battery voltage 3. R2, 2Q voltage transfer circuit from the processor to operate the relay without loading the processor.

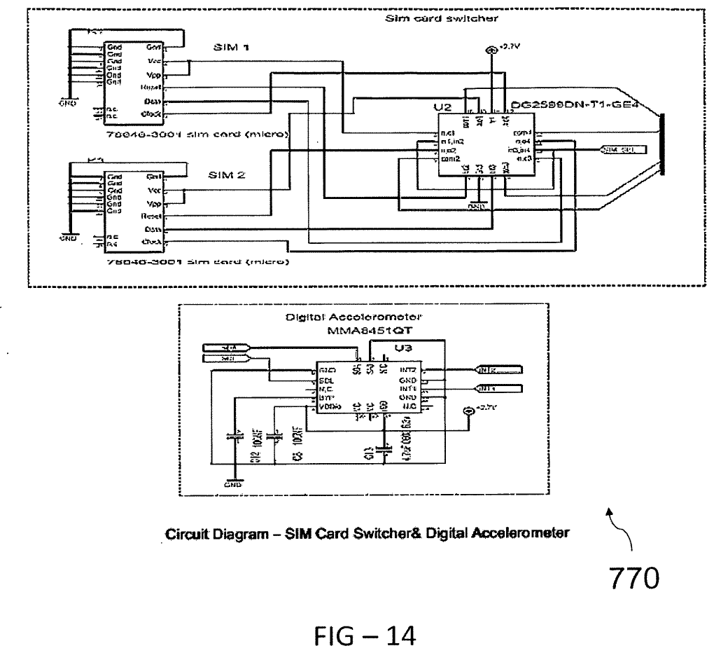

FIG. 14 of the method, system, and device of the present invention illustrate another implementation 770 of the present invention, wherein furthermore, such another implementation 770 of the present invention illustrate some technological components enable in the present invention system and electric circuits such as Cellular SIM enable to be controlled by cellular telephone and control the opening and closing of some bypass electric circuits of the present invention system, illustrate as one implementation enabled in some “remote-controlled implementations”, not wired implementations of the present invention, enabled in some implementation of the present invention. Wherein, in such implementation of the present invention, one skilled in the art can agreed that it is obvious that more component and technologies can be added to the present invention sections, such as “G.P.S” technology, “Global Positioning System”, that enable to locate the position of some vehicle that some of the present invention sections are installed in it.

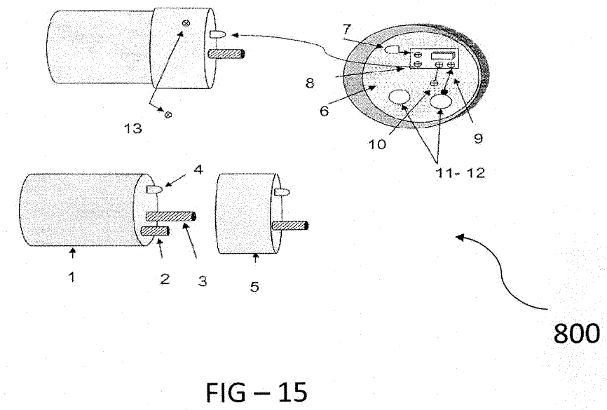

FIG. 15 of the present invention represents implementation 800 of the present invention as an example only, wherein, solenoid 1 represent the common existing solenoid, wherein, device 5 is the present invention new device, wherein, illustration 13 shows the solenoid 1 and the device 5 when they are connected 13.

Wherein, solenoid 1 electric connections 2 is the connection to the Starter coil voltage; 3 is the connection to the Battery voltage; and 4—is the Zero connection.

Wherein, on skilled in the art has to notice, that device 5 has the shape and functionality, that enable to accommodates, hide and protect solenoid 1 electric connections 2, 3, and 4—secured from contact, in the device 5, in a way, that make an extensions to these electric connection through the device 5, part of these extensions of the connections are hidden inside the device inner system 9—and again, the electric connections extensions are reviles in the outer side section of the device 5—enabling the connection to the starter.

However, the inner parts of the device 5, having the system 9, and the inner connecting means and extension of connections, further having electronic card, and an electric circuit act as a bypass to the solenoid electric connections and the starter —act as an on/off connection to the circuit—this operate the electronic card by remote-control signal. Such as of a cellular coded signal from cellular telephone, that operates the electronic card for example.

Wherein, when the present invention device and system 5 are connected to solenoid 1, inner part 9 of the device 5, illustrate in it, the electronic card 6, the connection of entering plus to the electronic card from the switch of the vehicle 7 (vehicle key). Exiting connection of plus to the solenoid; connecting zero connection 10 to the electronic card; enables connecting means to secure device 5 to solenoid 1, for example connector 13; wherein, box 14 is another implementation for Square shape device similar to device 5.

Wherein, at the device inner section and as part of its system, a G.P.S locating technologies enabled, for example, by cellular existing technologies enables by a cellular SIM and electronic card enabled in the present invention. Antenna, enabled to in the device and system of the present invention, to enables some remote-communication.

wherein, such method, system and device of immobilizer remotely control starter, comprises, a device having some shape fitted to cover and hide at-list part of the solenoid electric connections; wherein, such device having in it connecting means fitted to be connected to the solenoid electric connections, however yet not to be detachable from the outer side of the covering device. Wherein, a bypass to the electric connection is made in the device, and, outer connection from the device are to be connected to the vehicle starter, wherein, only the authorized person that send the signal, for example, a cellular signal from cellular telephone to the electric card and cellular SIM in the system that inside the device of the present invention—only the authorized person can close or open the bypass protected electric connection from the remote-control operation device of the user.

1. Method of installing and locating protective device and systems of the present invention to some vehicle solenoid, wherein, such protective device includes system of some electrical card include an electrical circuits and components designated to protect and control the vehicle starter operation, wherein such method includes the steps:
a. user using the present invention protective device to cover and close the access to some wired electric connection and components that are on the outer cover box of some solenoid, wherein;
b. such protective device designated with fitted shape that fitted to be connected to some section of such solenoid in away that it is hiding and closing some of the solenoid connection and electric wires and component that are reachable on such solenoid cover box outer surface, wherein;
c. such protected device fitted to cover at list the switch connector and wires that are on the solenoid box outer section, wherein;
d. such protective device enables to extent to its inner hollowed sections such switch connector and electric wires that reachable on such solenoid cover box outer surface, wherein;
e. such protective device enables in its inner hollowed sections to enable a system includes some electronic card dedicated with electrical circuits and technological components that enables to connect to some of such extensions of such switch connector and electric wires, wherein;
f. such connecting of such switch extension to such system are to be performed in a manner that enables to make another extension output for such switch wires and connectors from such system that will enabled to connect such switch wires and connectors to the vehicle switch in the driver vicinity, wherein;
g. at list in some of the way of such switch extension it will pass through a bypass electric circuits and components of the system, wherein;
h. such switch electric wiring and connectors and such system are to be closed in some sealed protective device, wherein;
I. such bypass electric circuits and components are to be controlled by some coded or privet technologies that allows only to authorized users to activates such bypass electric circuits and components.

2. The claim of claim 1 wherein, such coded or privet technologies enabled in wiring operation technologies such as by keyboard coded devices and systems.

3. The claim of claim 1 wherein, such coded or privet technologies that enabled in the present invention electric circuits and electric card and system of the present invention including also som thecnological component that enabling the closing and the opening of some bypass electric circutes of the present invention, by some remote controlled device and systems operation from the outside of the present invention devices and system, enabled coded or privet signals to enables such opening and closing of such bypass electric circuits, for example: by Cellular Sim operates by authorized telephone number, by telephone call; by Satellite controlled software.

4. Protective device designated to be connected and secured to some section of motorized vehicle solenoid unit in such manner that protect some electric connection of such solenoid, for the purpose of preventing access from unauthorized persons and to protect and control the vehicle starter operation by authorized users, wherein such device includes:
a. some section fitted by shape to be connected to some section of some solenoid sections in a way that such device preventing free access to some of such solenoid connections and electric wires and components, wherein;
b. such device covering, hiding and closing some of the solenoid connections and electric wires and components that are reachable on such solenoid cover box outer surface, wherein;
c. such protected device fitted to cover at list the switch connector and wires that is common openly accessible on the solenoid box outer section, wherein;
d. such protective device composed of an inner sections that are at list partially hollowed and fitted to accommodates some sections of the present invention such as the system of the present invention, some electric cards, some electric circuits, some technological components, some extension of components and electric wiring from the solenoid sections and to such solenoid, wherein;
e. such protective device accommodates and enables in some of its inner sections some electric card with electrical circuits and components as in the present invention, that enable some bypass electric circuit that designated to close and open some electricity flow to some wires and electric connectors of the vehicle switch that located on some section of such solenoid, wherein;
F. such protective device further accommodates and enables in some of its inner sections some electronic card, electric circuits and technological components that designated to control such bypass electric circuits opening and closing circutes, that designated to close and open some electricity flow to the electric connector of such solenoid, wherein;
g. such electronic, electrical circuits and technological components that designated to control such bypass electric circuits that designated to close and open some electricity flow to the electric connector of such solenoid are to be controlled from outside of such device by wired connections, or by remote control technologies and components and devices and systems, that enables to controls such closing and opening of such bypass electric circuits by some authorized coded signals that executed by some authorized users with wired or remote controlled devices and systems that controlled such technologies and components located in the present invention system and electric card, enables to controls such closing and opening of such bypass electric circuits, wherein;
h. such device of the present invention enables to close and lock such device on some of the solenoid sections, and enables to close and lock such electric cards and electric circuits and components that are located inside such device of the present invention, in some of its inner hollowed section, for the purpose of preventing unauthorized persons to activates the solenoid and the starter of some motorized vehicles for malicious purposes such as for stealing such vehicle

5. the device of claim 4, wherein such protective device accommodates some system including some electrical card, some electrical circuits and technological components as in the present invention that designated to protect and control some vehicle starter operation.

6. The device of claim 4, wherein furthermore, a. such protective device enables to performs in its inner sections some electric bypass and enables to performs some extensions to such switch connectors and electric wires that reachable on such solenoid cover box outer surface, wherein;
b. such protective device enables in its inner hollowed section to enable a system includes an electronic card dedicated with electrical circuits and technological components that enables to connect to them such extensions of such switch connector and electric wires, wherein;
c. such connecting of such switch extension to such system are to be performed in a manner that enables to make some necessary extension output for such switch wires and connectors from such system in the present device that will enabled to connect such switch wires and connectors to the vehicle switch, wherein;
d. at list in some of the way of such switch extension it will pass through a bypass electric circuits and components of the system, wherein;
e. such switch electric wiring and connectors and such system are to be closed in some sealed protective device section, wherein;
f. such bypass electric circuits and components are to be controlled by some privet coded or privet technologies enabled by devices and system that are wired or remote-controlled devices and system controls such bypass circuits and components in such manner that enables the closing and the opening controls of such bypass and components, enables only to authorized users to activates such bypass electric circuits and components, wherein;

7. The device of claim 6, wherein furthermore, some implementations of the present invention are to be performed by some remote-control technologies and devices that are designated to send some coded signals commend to open and to close such electric bypass circuits, thereof, such implementations are different from some wired implementations of the present invention, and will be performed without some of the wiring connections and electric extensions and connections to the solenoid surface and on the solenoid surface.

8. the claim as claimed in claim 5, wherein furthermore, coded or personal data of authorization can preformed by wired keyboards device and systems and its technological components that are connected to such electric bypass circuits or to its technological components that controls such bypass opening and closing circuit from the outside of such protective device of the present invention, wherein, such some wires of electric circuits and technological components are extended from the present invention device and its inner electric card, electric circuits and technological components to such controlled devices and system such as to the keyboard coded device and system.

9. the claim as claimed in claim 8, wherein furthermore, such controlled device and system enabled to be performed in the present invention by some remote-controls technologies and devices and system, such as:
a. by Cellular Sim that installed on the electric card of the present invention, in such way that enables to control the opening and the closing of such bypass circuits of the present invention by a remote telephone call from some authorized telephone number.
b. by satellite coded authorized signals that applies to some computerized chip and components and components dedicated with software's that installed in the electric card of the present invention in a manner that enables to controls by such technologies such components dedicated with software.
c. by remote controlled coden Bluetooth technology devices and systems, or RF (radio frequency), or other technologies available to enables the present invention operations.

10. the clam as claimed in claim 7, wherein, furthermore, such electric card of the present invention enables an installation of G.P.S. technological components, Global Positioning System, to enables more abilities related to the present invention goals, such as to enables the remote tracing and information of the location of such motorized vehicle that that such device and systems of the present invention are installed in it as claimed in the present invention.

11. The clam as claimed in claim 7, wherein furthermore, some implementations of the device of the present invention, enabled as fallowed:
First section of the protective device of the present invention designated to fit in its shapes to be attached on some of the solenoid outer box surface, in such manner that hide and prevents some of the access capability to some sections on such solenoid box, such as to some switch connections, wherein;
Furthermore, such section of the present invention protective device, enables some hollowed inner space in it, wherein;
Such hollowed inner space, and such device section, designated to enable accommodation of some of the components that are on the outside cover box of such solenoid, wherein;
Such device section, designated to enable passage of some of such component that are on the outside cover box of such solenoid, designated to enables some of the screws passage through some of the device section, and enable to fastening such screws from the inside of such inner device section, wherein;
Such device section is also designated to accommodate in it inner space some electric card and component and electric wires, such as in the present invention, wherein,
Such device section, designated to be sealed and locked by another section of such protective device, wherein, such another protective device designated with appropriate holes and connectors, that enabling to connect and, or to pass, some of such components and wires, wherein, at list some of these are to be connected to such another section of the present invention protective device from it outer surface, wherein;
The electric card and components having at list one bypass electric circuit that is controlled by some technological components as in the present invention.

12. System includes some electrical card an electric circuits and components and method of wiring, installing and locating such system to protective device of the present invention and to some solenoid sections designated to protect and control the vehicle solenoid and starter operation, wherein such system includes:
a. some electric card with electrical circuits and components as in the present invention, that enables some bypass electric circuits that designated to close or open some electricity flow to the wires and electric connectors of the switch that located on some such section of such solenoid, wherein;
b. such electronic card, electric circuits and technological components are designated to control such bypass electric circuits that designated to close or open some electricity flow to the electric connector of such solenoid are controlled from the outside of such device by wired connection, or by remote control technologies and components that are installed in such electric card, enables to controls such closing and opening of such bypass electric circuits by some coded applying that executed by some authorized users with wired or remote controlled devices that controlled such technologies and components, that enables to controls such closing and opening of such bypass electric circuits, wherein;
c. such system located at the present invention protective device, furthermore, such device accommodates the system in some of its inner sections these system sections of electronic card, electric circuits and technological components and extension of these through the protective device sections hollowed inner section, furthermore, connecting some sections of such system to some section and component of the solenoid and to the outer surface of such protective device and to some vehicle components, designated to control such bypass electric circuits that designated to close or open some electricity flow to the electric connector of such solenoid, wherein;
d. such system of the present invention enables to be close and lock in such device of the present invention, and protect some of the solenoid sections, particularly to prevent access from the switch electric wires and connectors that are exposed on the outside surface of the solenoid, and enables to close and lock such electric cards and electric circuits and components that are located inside such device of the present invention, in some of its inner hollowed section, for the purpose of preventing unauthorized persons to activates the solenoid and the starter of some motorized vehicles for malicious purposes such as for stealing such vehicle
e. wherein, such system located in such protective device of the present invention, such device that fitted by some of its sections shape to be connected to some sections of some solenoid sections in a way that such device prevents the access to some of such solenoid connections and electric wires and components by covering, hiding and closing some of the solenoid connections and electric wires and components that are reachable on such solenoid cover box outer surface, wherein;
f. such protected device fitted to cover at list some of the switch connectors and wires that is openly accessible on the solenoid box outer section, wherein;

13. The claim as claimed in claim 12, wherein furthermore, another implementation of the present invention enables, with some necessary changes and adjustments, such system of the present invention, including such electric card, electric wires and technological components and some extension of component, to be located and accommodate inside the solenoid covering protective box itself, wherein, in such implementation of the present invention, the covering box of some solenoid are pre-fitted and enlarged to the extent that enables to accommodate the system sections of the present invention, wherein;
In such implementation, when outer devices and system controlling by remote-control technologies the opening and the closing of the present invention electric bypass by controlling some technological components installed in the system of the present invention, some of the present invention extension and of electric wires to some controls devices and system are not required.

14. The claim as claimed in claim 13, wherein furthermore in such implementations, outer devices and system enabled in the present invention to be controlled by remote-control technologies, or by wired connections, to controls such opening and closing of the present invention electric bypass by controlling some technological components that are including in the system of the present invention.

15. The claim as claimed in claim 14, wherein furthermore some remote technologies and remote-control devices and system enabled in the present invention, not as a closed list bout as an examples, are:
a. by Cellular Sim that installed on the electric card of the present invention, in such way that enables to control the opening and the closing of such bypass circuits of the present invention by a remote telephone call from some authorized telephone number.
b. by satellite coded authorized signals that applies to some computerized chip and components and components dedicated with software's that installed in the electric card of the present invention in a manner that enables to controls by such technologies such components dedicated with software.
c. by remote controlled coden Bluetooth technology devices and systems, or RF (radio frequency), or other technologies available to enables the present invention operations.

16. The claim as claimed in claim 13, wherein furthermore some technologies that at list partially wired by an extension wires to the controls devices and systems that control the technological components in the present invention system, are for example and not as a closed list:
Keyboarded coded devices and system, which is preferably located at the vicinity of the driver in some vehicles.

17. Another implementations of the present invention enables, with some necessary changes and adjustments, such system of the present invention, including such electric card, electric wires and technological components and some extension of component, to be located and accommodate inside the original solenoid covering protective box itself, wherein, in such implementations of the present invention, the covering box of some solenoid are pre-fitted and enlarged to the extent that enables to accommodate the system sections of the present invention, wherein;
In such implementation, when outer devices and system controlling by remote-control technologies the opening and the closing of the present invention electric bypass by controlling some technological components installed in the system of the present invention, some of the present invention extension and of electric wires to some controls devices and system are not required.

18. The system as claimed in claim 12, wherein furthermore, the system designated to preventing the theft and use of a motorized vehicle by an unauthorized person, wherein, such system includes:
a. A cover protective container, the device of the present invention, fitted in shape to be attached and protect, some part of the solenoid electric connections; wherein,
b. Such device including, in one side of it connecting fitted to be attached to some solenoid electric connection—wherein, the device is to be secured to the solenoid, and the device connections connect to the solenoid electric connection and make them unreachable; wherein,
c. Extension of the electric connection of the solenoid to the inner parts and system of the device are built-in in the device and system of the present invention; wherein,
d. In the device, the system enabling a bypass electric circuit that neutralizing the direct connection of electric circuit between the solenoid and the vehicle starter; wherein,
e. The electric circuit including the bypass of on and off connection of the electric circuit—operated by electronic card by remote-control signal; wherein,
f. On the outside of the device are electric connections, that when the remote-control signal closing the electric circuit in the device—all the connections are committing the big electric circuit, between the solenoid and the vehicle starter—to the electric connection leading to the starter; wherein,
g. These are necessity needs for the operation of the vehicle starter duo to the present invention; wherein,
h. Part of the system in the container (the device), suitable for housing the system and connects to the solenoid electric connections, enabling and including a bypass electric circuit, that designated to enables a on and off controller that disable the direct electric connection between the solenoid and the starter of a motorized vehicle.

19. The system as in claim 18, wherein furthermore, electronic card operated by remote-control signal, wherein, operation is by the remotely disconnecting, or by connecting the electric supply to the solenoid.
